(19) United States
(12) Patent Application Publication
(10) Pub. No.: US 2026/0279769 A1
(43) Pub. Date: Sep. 17, 2026

(54) POSITIVE ELECTRODE FOR LITHIUM-ION ELECTROCHEMICAL CELL

(71) Applicant: SAFT, Levallois-Perret (FR)

(72) Inventors: Lucille GAL, EYSINES (FR); Jérémy HUMEZ, CENON (FR)

(73) Assignee: SAFT, Levallois-Perret (FR)

(21) Appl. No.: 19/469,069

(22) PCT Filed: Mar. 28, 2024
(86) PCT No.: PCT/EP2024/058433

§ 371 Date: Sep. 25, 2025

(30) Foreign Application Priority Data
Mar. 29, 2023 (FR) FR2303018

(51) Int. Cl. H01M 4/36; H01M 4/525; H01M 4/58; H01M 10/0525

(52) U.S. Cl. CPC H01M 4/364; H01M 4/525; H01M 4/5825; H01M 10/0525

(57) ABSTRACT

An electrode comprising a mixture of active materials, which mixture comprises: —a lithium nickel manganese oxide of formula LiₐNi_{1-x-y-z}MnₓCo_{y}M_{z}O₂ where 0.9≤a≤1.1; 0.60≤1-x-y-z<0.80; 0<x; 0≤y≤0.02; 0≤z; M being one or more elements chosen from the group consisting of Al, B, Mg, Si, Ca, Ti, V, Cr, Fe, Cu, Zn, Y, Zr, Nb, W, Mo, S, Sr, Ce, Ga, Ta, Nd, Pr, and La; and—a lithium manganese iron phosphate of formula LiₓMn_{1-y-z}Fe_{y}M_{z}PO₄ where 0.8≤x≤1.2; 0.5≤1-y-z<1; 0<y≤0.5; 0≤z≤0.2; M is one or more elements chosen from the group consisting of Al, B, Mg, Si, Ca, Ti, V, Cr, Co, Cu, Ni, Zn, Y, Zr, Nb, W and Mo.

### TECHNICAL FIELD OF THE INVENTION

The technical field of the present invention is that of active materials intended to be used in the cathode, that is to say the positive electrode, of an electrochemical cell of the lithium-ion type, also called lithium-ion cell.

### BACKGROUND OF THE INVENTION

Electrochemical cells of the lithium-ion type comprising a positive electrode whose active material is based on lithium phosphate of at least one transition metal are known in the state of the art. A lithiated phosphate of at least one transition metal typically has the formula LiMPO₄ where M represents at least one transition metal, such as Mn, Co, Ni, Fe or Mn associated with Fe. When Mn is combined with Fe, the lithium phosphate is abbreviated LMFP in the following.

Determining the state of charge of a cell whose positive electrode includes LMFP is difficult. Indeed, such a cell has, for states of charge generally between 30 and 80%, a so-called “flat” charge profile. Charge profile is understood to mean the curve representing the variation of the voltage of the cell as a function of time during charging. In the range of the states of charge comprised between 30 and 80%, the voltage of the cell increases very little, so that it is difficult to correlate the voltage of the cell with its state of charge. Moreover, when the end of charging is approaching, i.e. for a state of charge comprised between approximately 95 and 100%, the voltage of the cell increases sharply. Indeed, the delithiation of almost all the lithium present in the lithium phosphate causes a sudden increase in the voltage.

This surge means that it is not possible to warn a user sufficiently early of the imminence of overcharging. The voltage of the cell can quickly reach high values. Prolonged exposure of the cell to overcharging leads to degradation of the electrolyte and a reduction in the lifetime of the cell.

Methods of detecting the end of charging of cells having a positive electrode based on LMFP have been sought to warn a user sufficiently early of the imminent end of charging of the cell. Document FR 3122286 teaches, for example, the use, mixed with LMFP, of a nickel, manganese and cobalt oxide, abbreviated NMC, rich in nickel or a lithium-containing nickel, cobalt and aluminum oxide, abbreviated NCA, also rich in nickel. The term nickel-rich-indicates a nickel stoichiometric index of at least 0.80 for NMC. It designates a stoichiometric index of nickel of at least 0.83 for NCA.

However, a gradual dissolution of the manganese and nickel of the NMC and NCA oxides in the electrolyte of the cell was observed. The consequence of this dissolution is a progressive reduction in the discharge capacity of the cell, and therefore a reduction in its lifetime. It is therefore sought to reduce the dissolution of manganese and nickel while retaining the possibility of accurately determining the end of the charge of the cell whose positive electrode is based on LMFP.

### SUMMARY OF THE INVENTION

To this end, the invention provides an electrode comprising a mixture of active materials, which mixture comprises:
a monocrystalline lithium nickel manganese oxide (NMx) of the formula LiₐNi_{1-x-y-z}MnₓCo_{y}M_{z}O₂ where 0.9≤a≤1.1; 0.60≤1-x-y-z<0.80; 0<x; 0≤y≤0.02; 0≤z; M being one or more elements chosen from the group consisting of Al, B, Mg, Si, Ca, Ti, V, Cr, Fe, Cu, Zn, Y, Zr, Nb, W, Mo, S, Sr, Ce, Ga, Ta, Nd, Pr, and La; and
a lithium manganese iron phosphate (LMFP) of the formula LiₓMn_{1-y-z}Fe_{y}M_{z}PO₄ where 0.8≤x≤1.2; 0.5≤1-y-z<1; 0<y≤0.5; 0≤z≤0.2; M being one or more elements chosen from the group consisting of Al, B, Mg, Si, Ca, Ti, V, Cr, Co, Cu, Ni, Zn, Y, Zr, Nb, W and Mo.

It has been found that by using monocrystalline NMx and choosing the stoichiometric indices of nickel, manganese and cobalt within the following ranges, respectively: 0.60≤1-x-y-z<0.80; 0<x and 0≤y≤0.2, it was possible to reduce the dissolution of nickel and manganese while maintaining or improving the ability to accurately detect the end of the charge of the cell.

According to one embodiment, the mixture of active materials consists of:
10 to 70% or 20 to 40% by mass of the monocrystalline lithium nickel manganese oxide.
90 to 30% or 80 to 60% by mass of the lithium manganese iron phosphate.

According to one embodiment, in monocrystalline lithium nickel manganese oxide, 0.60<1-x-y-z or 0.60≤1-x-y-z≤0.75.

According to one embodiment, in monocrystalline lithium nickel manganese oxide, 0.005≤y≤0.15, or y=0.

According to one embodiment, the monocrystalline lithium nickel manganese oxide has a particle size distribution characterized by a volume median diameter Dv₅₀ ranging from 1 to 7 μm, preferably ranging from 1 to 4 μm.

According to one embodiment, in lithium manganese iron phosphate, 0.7≤1-y-z≤0.9.

The invention also relates to a lithium-ion electrochemical cell comprising at least one positive electrode that is the electrode described above and at least one negative electrode.

According to one embodiment, said at least one negative electrode comprises an active material chosen from graphite, silicon, titanium oxide, a lithium titanium oxide, a titanium and niobium oxide and a mixture thereof.

The invention also relates to method for improving the detection of the end of charging of a lithium-ion electrochemical cell comprising a positive electrode comprising a lithium manganese iron phosphate of the formula LiₓMn_{1-y-z}Fe_{y}M_{z}PO₄ where 0.8≤x≤1.2; 0.5≤1-y-z<1; 0<y≤0.5; 0≤z≤0.2; M being one or more elements chosen from the group consisting of Al, B, Mg, Si, Ca, Ti, V, Cr, Co, Cu, Ni, Zn, Y, Zr, Nb, W and Mo, said method comprising:
a) replacing during the manufacture of a positive electrode of a portion of lithium manganese iron phosphate by a monocrystalline lithium nickel manganese oxide of formula LiₐNi_{1-x-y-z}MnₓCo_{y}M_{z}O₂ where 0.9≤a≤1.1; 0.60≤1-x-y-z<0.80; 0<x; 0≤y≤0.02; 0≤z; M being one or more elements chosen from the group consisting of Al, B, Mg, Si, Ca, Ti, V, Cr, Fe, Cu, Zn, Y, Zr, Nb, W, Mo, S, Sr, Ce, Ga, Ta, Nd, Pr, and La;
b) correlating the voltage of the cell with its state of charge.

The method can be implemented in the case where the positive electrode of the cell is as described above.

### BRIEF DESCRIPTION OF THE FIGURES

Embodiments of the invention are described below in greater detail with reference to the attached figures.

FIG. 1 shows the charge/discharge curves at the first cycle of cells comprising the positive electrodes A to E of the examples.

FIG. 2 shows the curves dQ/dV of the active materials of the electrodes A and B.

FIG. 3 shows the differential scanning calorimetry curves obtained on the mixtures of active materials of the electrodes C and D.

### DESCRIPTION OF EMBODIMENTS OF THE INVENTION

### Positive Electrode

At least one positive electrode of the cell comprises a current collector, at least one of the faces of which is coated with a layer of a composition of positive active materials. The “composition of active materials” is understood to mean a composition comprising the mixture of active materials and optionally one or more binders and one or more electronically conductive materials.

The positive current collector is a solid or perforated metal strip which may be made of aluminum or an aluminum alloy or steel or stainless steel. Its thickness may be in the range from 6 to 30 μm or from 5 to 20 μm or from 10 to 15 μm, preferably from 10 to 15 μm.

Before the current collector is coated with the layer of composition of active materials, it may be coated, on one of its faces or on both its faces, with a coating intended to improve the electronic conductivity between the layer of composition of active materials and the strip and/or to improve the adhesion of the layer of composition of active materials to the strip. The coating material may be chosen from the group consisting of carbon, graphite, carbon fibers, carbon nanotubes, and mixtures thereof. It is preferably made of carbon. The coating material may be obtained by coating the strip with a dispersion of the material and then evaporating the solvent from the dispersion, or it may be obtained by sputtering. Only certain parts of the strip may be coated with the coating material. The coated portions may be separated from each other by predetermined or periodic intervals (“intermittent coating”). The intermittent coating is preferably present on both sides of the strip. It facilitates the treatment of the electrode. In a variant, one or both faces of the strip may have undergone a surface treatment intended to increase the adhesion of the layer of composition of active materials to the strip. It may be a surface treatment creating roughness or microroughness, such as chemical etching or laser treatment.

The mixture of active materials comprises at least one monocrystalline lithium nickel manganese oxide NMx and at least one lithium manganese iron phosphate LMFP. A monocrystal is a solid consisting of a single crystal, formed from a single seed. Synonymous terms that can be used are the following: single crystal material or monocrystalline material, commonly called “single crystal” by persons in the field. The term single crystal or monocrystalline is also used with reference to a morphology for which a secondary particle is ideally constituted by a single primary particle.

NMx is a compound of formula (I) LiₐNi_{1-x-y-z}MnₓCo_{y}M_{z}O₂ where 0.9≤a≤1.1; 0.60≤1-x-y-z<0.80; 0<x; 0≤y≤0.02; 0≤z; M being one or more elements chosen from the group consisting of Al, B, Mg, Si, Ca, Ti, V, Cr, Fe, Cu, Zn, Y, Zr, Nb, W, Mo, S, Sr, Ce, Ga, Ta, Nd, Pr and La.

The stoichiometric index of nickel of at least 0.60 provides a sufficiently high electrochemical capacity of the positive electrode. In one embodiment, 0.65≤1-x-y-z<0.80 or 0.70≤1-x-y-z<0.80 or 0.75≤1-x-y-z<0.80. Conversely, a nickel stoichiometric index value greater than or equal to 0.8 adversely affects the stability of the lithium nickel oxide when it is exposed to either high temperature or a potential greater than 4.3 V vs. Li. The choice of a stoichiometric index comprised between 0.6 and less than 0.8, preferably around 0.75, makes it possible to provide a positive electrode having both a high electrochemical capacity and good stability from the thermal and electrochemical point of view.

According to one embodiment, the stoichiometric index of manganese is within the following ranges: 0.20<x≤0.40 or 0.25≤x≤0.30.

According to one embodiment, the stoichiometric index of cobalt lies in the following ranges: 0.001≤y≤0.015 or 0.005≤y≤0.010 or 0.001≤y≤0.005. Preferably, y=0. The small quantity of cobalt in NMx, or even the total absence of cobalt, deals with the problem of cobalt rarefaction.

According to one embodiment, z=0.

According to one embodiment, y=0 and z=0.

According to one embodiment, y=0, z=0, 0.20<x≤0.40 and 0.60≤1-x<0.80.

According to one embodiment, y=0, z=0, 0.20<x≤0.30 and 0.70≤1-x<0.80.

Examples of preferred compounds are LiNi_{0.65}Mn_{0.35}O₂, LiNi_{0.70}Mn_{0.30}O₂ and LiNi_{0.75}Mn_{0.25}O₂.

The applicant found that the tendency of NMx to release nickel and manganese into the electrolyte was less than that of LiNi_{0.8}Mn_{0.1}Co_{0.1}O₂ (NMC811). This advantage can be attributed on the one hand to the monocrystalline nature of NMx and on the other hand to different stoichiometric coefficients of nickel, manganese and cobalt. The invention therefore makes it possible to increase the lifetime of the cell with respect to a cell whose positive electrode would contain NMC811.

A parameter characterizing the size distribution of the single crystals is the median volume diameter Dv₅₀ of the single crystals. The expression “median volume diameter Dv₅₀” means that, in a given population of particles, 50% of the volume of the particles consist of particles having an equivalent diameter less than the Dv₅₀ value and 50% of the volume of the particles consist of particles having an equivalent diameter equal to or greater than the Dv₅₀ value. The expression “equivalent diameter” of a particle designates the diameter of a sphere having the same volume as this particle. The Dv₅₀ of NMx generally ranges from 1 to 7 μm or from 1 to 4 μm. A value greater than 7 μm will generally indicate that it is a polycrystal. Dv₅₀ can be measured using the laser diffraction technique.

The monocrystalline NMx space group is the R 3m group (trigonal system). It can be verified that the space group of the monocrystalline NMx is the R 3m group by means of X-ray diffraction.

According to one embodiment, the NMx particles are devoid of any coating, in particular a coating that would consist of LMFP or a coating of a metal oxide.

LMFP is a compound of the formula (II) LiₓMn_{1-y-z}Fe_{y}M_{z}PO₄ where 0.8≤x≤1.2; 0.5≤1-y-z<1; 0<y≤0.5; 0≤z≤0.2; M being one or more elements chosen from the group consisting of Al, B, Mg, Si, Ca, Ti, V, Cr, Co, Cu, Ni, Zn, Y, Zr, Nb, W and Mo.

According to one embodiment, 0.5<1-y-z<1 or 0.7≤1-y-z≤0.9 or 0.75≤1-y-z≤0.80.

Examples of preferred LMFP compounds are LiMn_{0.8}Fe_{0.2}PO₄, LiMn_{0.78}Fe_{0.22}PO₄, LiMn_{0.7}Fe_{0.3}PO₄, LiMn_{2/3}Fe_{1/3}PO₄ and LiMn_{0.5}Fe_{0.5}PO₄.

LMFP can be coated with carbon or carbon nanotubes.

LMFP can be either in the form of disjoint particles, also called primary particles, or in the form of agglomerates of primary particles, also called secondary particles. LMFP may be in the form of secondary particles having a median volume diameter Dv₅₀ in the range of 1 to 15 μm or 1.5 to 4 μm.

The proportions of LMFP and NMx in the active material mixture may be as follows:
10 to 70% by mass of monocrystalline NMx, and
90 to 30% by mass of LMFP, or
20 to 40% by mass of monocrystalline NMx, and
80 to 60% by mass of LMFP, or
25 to 35% by mass of monocrystalline NMx, and
75 to 65% by mass of LMFP.

The invention excludes the LMFP active material from being a coating of the NMx particles.

The active material composition may comprise a plurality of monocrystalline lithium nickel manganese oxides of formula (I) and a plurality of lithium manganese iron phosphates of formula (II). Preferably, the positive active material composition does not contain active materials other than compounds of formula (I) or (II).

The binder generally used in the composition of active materials reinforces the cohesion between the particles of active materials and improves the adhesion of the layer of active material composition to the current collector. The binder may contain one or more of the following compounds; and its copolymers, polytetrafluoroethylene (PTFE) and its copolymers, polyacrylonitrile (PAN), poly(methyl or butyl methacrylate), poly(vinyl chloride) (PVC), poly(vinyl formal), polyester, block polyether-amides, polymers of acrylic acid, methacrylic acid, acrylamide, itaconic acid, sulfonic acid, elastomers, and cellulose compounds such as carboxymethylcellulose (CMC). The elastomers that can be used as binder may be chosen from styrene-butadiene (SBR), butadiene-acrylonitrile (NBR) and hydrogenated butadiene-acrylonitrile (HNBR).

The binder may represent from 1% to 10% or from 1% to 5% or from 2% to 5% of the mass of the dry composition of active materials.

The electronically conductive material is generally chosen from graphite, carbon black, acetylene black, soot, graphene, carbon fibers, single-wall carbon nanotubes, multi-wall carbon nanotubes, and mixtures thereof. It may represent from 0.1 to 10% or from 0.1 to 5% of the mass of the dry composition of active materials.

### Preparing the Positive Electrode:

An ink is prepared by dispersing one or more LMFP active materials and one or more NMx active materials in a solvent or mixture of solvents. Optionally, a binder and an electronically conductive material are added to the dispersion. By varying the quantity of solvent incorporated in the mixture, it is possible to vary the viscosity of the ink before it is deposited on one face of the current collector. The ink-coated current collector is dried and then laminated to adjust its thickness. After evaporation of the solvent(s), a layer of an active material composition is obtained, the proportions of the various constituents of which are typically:
80 to 98% or 90 to 95% by mass of positive active materials,
1 to 10% or 2 to 5% by mass of binder(s),
0.1 to 10% or 2 to 5% by mass of electronically conductive material.

### Negative Electrode:

At least one negative electrode comprises a current collector, at least one of the two faces of which is coated with a layer of a composition of negative active materials. The negative active material composition comprises at least one negative active material and optionally a binder and an electronically conductive material. The negative current collector is a solid or perforated metal strip that can be made of copper or a copper-based alloy. Its thickness may range from 3 to 10 μm, preferably from 5 to 8 μm.

Before the current collector is coated with the layer of composition of active materials, it may be coated, on one of its faces or on both its faces, with a coating intended to improve the electronic conductivity between the layer of composition of active materials and the strip and/or to improve the adhesion of the layer of composition of active materials to the strip. The coating material and the coating deposition process may be the same as those described for the current collector of the positive electrode.

The negative active material is preferably chosen from carbon, graphite, coke, carbon black, glassy carbon, silicon, silicon, a silicon-carbon composite, silicon carbide, titanium oxide, lithium titanium oxide, titanium and niobium oxide and a mixture thereof. The titanium oxide may be chosen from H₂Ti₆O₁₃, H₂Ti₁₂O₂₅ and TiO₂. The lithium titanium oxide may be chosen from Li₄Ti₅O₁₂, Li₂TiO₃, Li₂Ti₃O₇, LiTi₂O₄ and Li₂Na₂Ti₆O₁₄. The titanium niobium oxide may be chosen from TiNb₂O₇, Ti₂Nb₂O₉ and Ti₂Nb₁₀O₂₉.

### Method for Preparing the Negative Electrode:

The negative electrode is prepared in a conventional manner. An ink is prepared by dispersion in a solvent or in a mixture of solvents of one or more negative active materials, optionally with a binder. The binder may be such as those described in relation to the positive electrode.

The ink-coated current collector is dried and then laminated to adjust its thickness. A negative electrode is thus obtained.

Typical proportions of the components of the negative active material composition layer, after evaporation of the solvent contained in the ink, are:
85 to 98% or 90 to 98% by mass of negative active materials,
1 to 10% or 1 to 5% by mass of binder(s),
0 to 5% by mass or 1 to 5% of an electronically conductive material.

### Electrolyte:

The electrolyte may be liquid. It is obtained by dissolving one or more lithium salts in one or more organic solvents. The solvent may be chosen from saturated cyclic carbonates, unsaturated cyclic carbonates, noncyclic carbonates, alkyl esters, ethers, solvents of the nitrile type and tetrahydrothiophene dioxide (sulfolane).

Saturated cyclic carbonates include ethylene carbonate (EC), fluoroethylene carbonate (FEC), propylene carbonate (PC), butylene carbonate (BC), and mixtures thereof.

Unsaturated cyclic carbonates include vinylene carbonate (VC).

Non-cyclic carbonates include dimethyl carbonate (DMC), diethyl carbonate (DEC), methyl ethyl carbonate (MEC), dipropyl carbonate (DPC), and mixtures thereof.

Alkyl esters include methyl acetate, ethyl acetate, methyl propionate, ethyl propionate, butyl propionate, methyl butyrate, ethyl butyrate, propyl butyrate, and mixtures thereof.

Ethers include dimethyl ether (DME), diethyl ether (DEE) and mixtures thereof.

The lithium salt may be chosen from lithium perchlorate LiClO₄, lithium hexafluorophosphate LiPF₆, lithium tetrafluoroborate LiBF₄, lithium hexafluoroarsenate LiAsF₆, lithium hexafluorantimonate LiSbF₆, lithium trifluoromethanesulfonate LiCF₃SO₃, lithium bis(fluorosulfonyl)imide Li(FSO₂)₂N (LiFSI), lithium bis(trifluoromethanesulfonyl)imide LiN(CF₃SO₂)₂ (LiTFSI), lithium tris(fluoromethanesulfonyl)methylide LiC(CF₃SO₂)₃ (LiTFSM), lithium bis(pentafluoroethylsulfonyl)imide LiN(C₂F(SO₂)₂ (LiBeTI), lithium-4,5-dicyano-2-(trifluoromethyl)imidazolide (LiTDI), lithium bis(oxalato)borate (LiBOB), lithium difluoro(oxalato)borate (LIDFOB), lithium tris(pentafluoroethyl)trifluorophosphate LiPF₃ (CF₂CF₃)₃ (LiFAP), lithium difluorophosphate LiPO₂F₂, and mixtures thereof.

The concentration of the at least one lithium salt can be in the range of 0.75 to 1.5 mol/L. It is preferably in the range from 1 to 1.5 mol/L. It is even better in the range from 1 to 1.2 mol/L.

### Separator:

A separator is interposed between a positive electrode and a negative electrode. The material of the separator may be chosen from the following materials: a polyolefin, for example polypropylene PP, polyethylene PE, a polyester, glass fibers bonded by a polymer, polyimide, polyamide, polyaramid, polyamide-imide and cellulose. The polyester may be chosen from polyethylene terephthalate (PET) and poly(butylene terephthalate) (PBT). Advantageously, the polyester or polypropylene- or polyethylene contains or is coated with a ceramic material chosen from the group consisting of metal oxides, carbides, nitrides, borides, silicides and sulfides. This ceramic material can be SiO₂ or Al₂O₃. The separator may be a ceramic coated polyolefin layer, preferably a polyethylene layer coated with ceramic on both sides.

### Preparation of the Electrochemical Bundle:

An electrochemical plate group is formed by interposing a separator between at least one positive electrode and at least one negative electrode. The electrochemical plate group is inserted into the cell container. The cell container may be parallelepipedal or cylindrical. In the latter case, the electrochemical plate group is spiraled to form a cylindrical assembly of the electrodes.

### Filling and Closing the Container:

A lid is assembled on the container of the cell, for example by laser welding. The cell container is filled with the electrolyte. To this end, the cover may comprise a filling hole through which the electrolyte is introduced. Once the electrolyte has been introduced, this filling hole is closed by a stainless steel ball by electrically welding the ball to the hole.

### EXAMPLES

Five positive electrodes A-E were prepared. They differ in their active materials. Table 1 shows the active materials used. In this table, LMFP is LiMn_{0.78}Fe_{0.22}PO₄; NMx is monocrystalline LiNi_{0.75}Mn_{0.25}O₂ and NMC811 is LiNi_{0.80}Mn_{0.1}Co_{0.1}O₂.

TABLE 1

| A* | B* | C | D* | E* |
|---|---|---|---|---|
| NMx | NMC811 | 30% NMx + | 30% NMC811 + | LMFP |
| | | 70% LMFP | 70% LMFP | |

* Non-invention electrode

The electrodes were exposed to a voltage of 4.5 V vs. Li metal for 7 days. The quantity of metal released by the positive electrode and found on the negative electrode was measured after these 7 days of exposure to 4.5 V. Table 2 presents the results of the measurements obtained.

TABLE 2

| | | | C | D* |
|---|---|---|---|---|
| | A* | B* | 30% NMx + | 30% NMC811 + |
| | NMx | NMC811 | 70% LMFP | 70% LMFP |
| Ni (%** ) | 0.0017 | 0.0028 | 0.0012 | 0.0020 |
| Mn (%** ) | 0.0010 | 0.0009 | 0.0003 | 0.0004 |
| Total | 0.0027 | 0.0037 | 0.0015 | 0.0024 |

*Non-invention electrode
**Quantity of nickel or manganese measured at the negative electrode at the end of the test and expressed as a percentage of the corresponding quantity initially present at the positive electrode.

It is found that electrode C containing a mixture of NMx and LMFP is the one for which the quantity of nickel and the quantity of manganese released are the lowest. This result is surprising. Indeed, the percentage of nickel released by electrode C is 40% lower than the percentage of nickel released by electrode D, whereas the stoichiometric index of nickel is 0.75 in NMx and 0.80 in NMC811, i.e. only 6% lower in NMx. Moreover, it is found, with regard to manganese, that there is no proportionality between the percentage of manganese released by the electrode and the stoichiometric index of manganese in the lithium oxide. Indeed, NMx contains 2.5 times more manganese than NMC811. However, the percentage of manganese released by electrode C containing NMx is less than that released by electrode D containing NMC811.

The applicant also observed that replacing NMC811 with NMx in a mixture with LMFP improves the accuracy of determining the state of charge of the cell as it approaches the fully charged state.

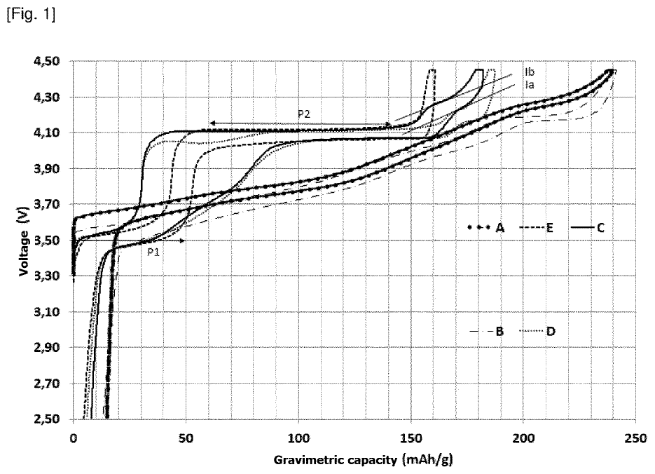

The charge/discharge curves of the five cells A-E comprising a lithium metal negative electrode have been plotted between the voltages of 2.5 V and 4.45 V. They are shown in FIG. 1 for the first cycle.

The voltage of cell B including NMC811 varies proportionally with the state of charge of the cell up to approximately 80% of full charge. Beyond 80%, the charge/discharge curve has a horizontal plateau which makes the determination of the state of charge of the cell inaccurate based solely on knowledge of its voltage. The voltage of cell A including NMx also varies proportionally to the state of charge of the cell, even above 80% of the full charge. The use of NMx therefore allows a more precise detection of the end of the charge.

The charge/discharge curve of cell E comprising LMFP alone has two plateaus: a first plateau P1 at approximately 3.50 V attributable to iron and a second plateau P2 at approximately 4.1 V attributable to manganese. Detection of the proximity of the end of the charge is difficult given the sudden rise in the voltage at the end of the second plateau P2. The replacement of 30% of the LMFP by NMC811 (curve D) makes it possible, on the one hand, to increase the mass capacity of the electrode and, on the other hand, to cause the voltage to gradually increase at the approach of the end of charging in the form of an inclined part (Ia) whose middle is situated at approximately 4.2 V. Replacing 30% of LMFP by NMx (curve C) also makes it possible to increase the capacity per unit mass relative to LMFP alone, but it also increases the voltage of the inclined part Ib to approximately 4.3 V instead of 4.2 V for the inclined part Ia. The difference between the inclined part Ib and the plateau P2 of the manganese at 4.1 V is greater than the difference between the inclined part Ia and the plateau P2 of the manganese at 4.1 V. Because of this greater difference, it is possible to establish a more precise correlation between the voltage of the cell and its state of charge.

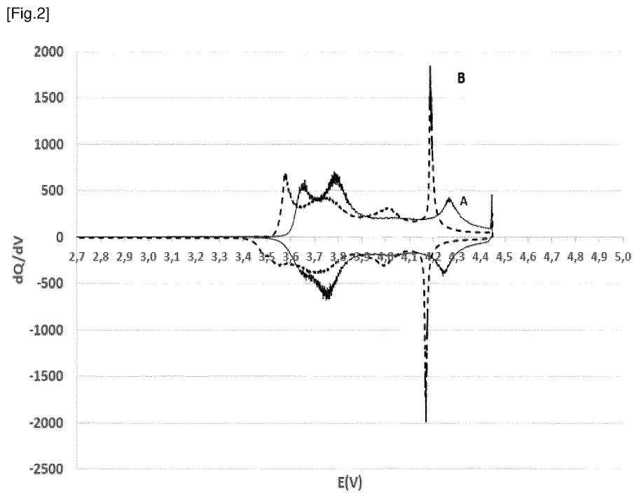

The applicant found that NMx had better oxidation stability than NMC811 when the applied potential exceeds 4.3 V vs. Li. FIG. 2 compares the curves dQ/dV of the active materials A and B which are respectively NMx and NMC811. The high intensity peak at approximately 4.2 V indicates that at this potential significant structural degradation of NMC811 occurs. This indicates that a charge of NMC811 to a potential greater than 4.2 V significantly degrades the structure of the material. In contrast, NMx has a much lower peak intensity than NMC811. Moreover, the peak of NMx appears at a potential greater than 4.2 V. It is therefore possible to charge NMx to a potential of 4.45 V without significantly degrading the structure of the material. This advantage is applied in the invention to exploit a wider potential range of up to 4.45 V instead of 4.3 V for NMC811, thus making it possible to increase the accuracy of the determination of the state of charge near the end of the charge. All these results demonstrate the possibility of reducing the dissolution of nickel and manganese while improving the detection of the end of the charge.

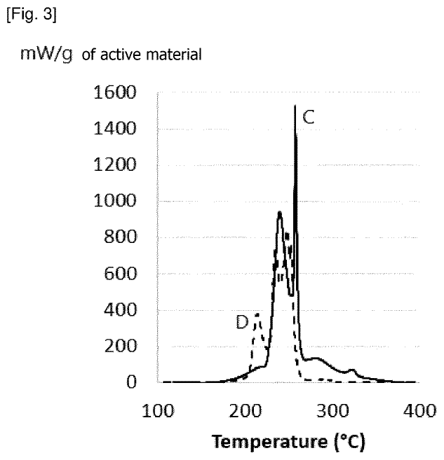

An additional benefit of replacing NMC811 with NMx is to provide a greater safety margin for the user of the cell in the event of an increase in temperature. The technique of differential scanning calorimetry has been used to detect the temperature at which the release of heat by the mixtures of active materials of the electrodes C and D begins when the latter are subjected to a rise in temperature. These results, shown in FIG. 3, show that the release of heat occurs from 200° C. for the mixture of active materials of non-invention electrode D, whereas it is necessary to reach approximately 230° C. to observe a release of heat for the mixture of active materials of electrode C.

Finally, replacing a portion of the LMFP with NMx increases the energy per unit mass and capacity per unit mass relative to a cell whose positive active material is LMFP alone. This is evidenced by the results in Table 3.

TABLE 3
Charge at 4.45 V vs. Li⁺/Li

| | E* | C | Gain (%) |
|---|---|---|---|
| Wh/kg | 601 | 679 | +13% |
| mAh/kg | 156 | 175 | +12% |

*Non-invention electrode

1. An electrode comprising a mixture of active materials, which mixture comprises:
a monocrystalline lithium nickel manganese oxide of the formula LiₐNi_{1-x-y-z}MnₓCo_{y}M_{z}O₂ where 0.9≤a≤1.1; 0.60≤1-x-y-z<0.80; 0<x; 0≤y≤0.02;
0≤z; M being one or more elements chosen from the group consisting of Al, B, Mg, Si, Ca, Ti, V, Cr, Fe, Cu, Zn, Y, Zr, Nb, W, Mo, S, Sr, Ce, Ga, Ta, Nd, Pr, and La; and
a lithium manganese iron phosphate of the formula LiₓMn_{1-y-z}Fe_{y}M_{z}PO₄ where 0.8≤x≤1.2; 0.5≤1-y-z<1; 0<y≤0.5; 0≤z≤0.2; M being one or more elements chosen from the group consisting of Al, B, Mg, Si, Ca, Ti, V, Cr, Co, Cu, Ni, Zn, Y, Zr, Nb, W and Mo.

2. The electrode according to claim 1, wherein the mixture of active materials is composed of:
10 to 70% by mass of monocrystalline lithium nickel manganese oxide;
90 to 30% by mass of lithium manganese iron phosphate.

3. The electrode according to claim 2, wherein the mixture of active materials is composed of:
20 to 40% by mass of monocrystalline lithium nickel manganese oxide;
80 to 60% by mass of lithium manganese iron phosphate.

4. The electrode according to claim 1, wherein in the monocrystalline lithium nickel manganese oxide, 0.60<1-x-y-z.

5. The electrode according to claim 1, wherein in the monocrystalline lithium nickel manganese oxide, 0.60≤1-x-y-z≤0.75.

6. The electrode according to claim 1, wherein in the monocrystalline lithium nickel manganese oxide, 0.005≤y≤0.015.

7. The electrode according to claim 1, wherein in the monocrystalline lithium nickel manganese oxide, y=0.

8. The electrode according to claim 1, wherein the monocrystalline lithium nickel manganese oxide has a particle size distribution characterized by a volume median diameter Dv₅₀ ranging from 1 to 7 μm, preferably ranging from 1 to 4 μm.

9. The electrode according to claim 1, wherein in the lithium manganese iron phosphate, 0.7≤1-y-z≤0.9.

10. A lithium-ion electrochemical cell comprising:
at least one positive electrode that is an electrode according to claim 1;
at least one negative electrode.

11. The lithium-ion electrochemical cell according to claim 10, wherein said at least one negative electrode comprises an active material chosen from graphite, silicon, titanium oxide, a lithium titanium oxide, a titanium and niobium oxide and a mixture thereof.

12. A method for improving the detection of the end of charge of a lithium-ion electrochemical cell comprising a positive electrode comprising a lithium manganese iron phosphate of the formula LiₓMn_{1-y-z}Fe_{y}M_{z}PO₄ where 0.8≤x≤1.2; 0.5≤1-y-z<1; 0<y≤0.5; 0≤z≤0.2; M being one or more elements chosen from the group consisting of Al, B, Mg, Si, Ca, Ti, V, Cr, Co, Cu, Ni, Zn, Y, Zr, Nb, W and Mo, said method comprising:
a) replacing during the manufacture of a positive electrode of a portion of lithium manganese iron phosphate by a monocrystalline lithium nickel manganese oxide of formula
LiₐNi_{1-x-y-z}MnₓCo_{y}M_{z}O₂ where 0.9≤a≤1.1; 0.60≤1-x-y-z<0.80; 0<x; 0≤y≤0.02; 0≤z; M being one or more elements chosen from the group consisting of Al, B, Mg, Si, Ca, Ti, V, Cr, Fe, Cu, Zn, Y, Zr, Nb, W, Mo, S, Sr, Ce, Ga, Ta, Nd, Pr, and La;
b) correlating the voltage of the cell with its state of charge.

13. The method according to claim 12, wherein the positive electrode is comprises a mixture of active materials, which mixture comprises:
a monocrystalline lithium nickel manganese oxide of the formula LiaNi1 x y zMnxCoyMzO2 where 0.9≤a≤1.1; 0.60≤1-x-y-z<0.80; 0<x; 0≤y≤0.02;
0≤z; M being one or more elements chosen from the group consisting of Al, B, Mg, Si, Ca, Ti, V, Cr, Fe, Cu, Zn, Y, Zr, Nb, W, Mo, S, Sr, Ce, Ga, Ta, Nd, Pr, and La; and
a lithium manganese iron phosphate of the formula LixMn1-y-zFeyMzPO4 where 0.8≤x≤1.2; 0.5≤1-y-z<1; 0<y≤0.5; 0≤z≤0.2; M being one or more elements chosen from the group consisting of Al, B, Mg, Si, Ca, Ti, V, Cr, Co, Cu, Ni, Zn, Y, Zr, Nb, W and Mo.

14. The electrode according to claim 8, wherein the monocrystalline lithium nickel manganese oxide has a particle size distribution characterized by a volume median diameter Dv₅₀ ranging from 1 to 4 μm.
